(19) United States
(12) Patent Application Publication
(10) Pub. No.: US 2008/0151722 A1
(43) Pub. Date: Jun. 26, 2008

(54) Optical disc device and method for discriminating different kinds of optical discs

(75) Inventors: Satoshi Hara, Yokohama (JP); Takeshi Imai, Fujisawa (JP); Toshio Saitoh, Matsudo (JP); Hiroyuki Ichikawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/891,943

(22) Filed: Aug. 13, 2007

(30) Foreign Application Priority Data
Dec. 26, 2006 (JP) 2006-349793

(51) Int. Cl. G11B 7/00

(52) U.S. Cl. 369/53.23

(57) ABSTRACT

This invention provides an optical disc device and method for discriminating between DVD and HD-DVD more rapidly. After an optical pickup has been stopped above a data region on the optical disc, a tracking error signal generator acquires amplitude “Vdpp” based on a DPP method and amplitude “Vdpd” based on a DPD method as tracking error signals. A disc discriminator discriminates the kind of optical disc by comparing the acquired “Vdpp” and “Vdpd” data with a threshold level “Vth”. Alternatively, the optical pickup is stopped above the data region and a system lead-in region on the optical disc, and then amplitude values “Vdata” and “Vlead” of tracking error signals are acquired and compared.

### CLAIM OF PRIORITY

The present invention claims priority from Japanese application serial No. JP 2006-349793, filed on Dec. 26, 2006, the content of which is hereby incorporated by reference into this application.

### BACKGROUND OF THE INVENTION

1. Field of the Invention

The present invention relates to an optical disc device capable of discriminating different kinds of optical discs, inclusive of large-capacity optical discs, and to a method for discriminating the kinds of optical discs.

2. Description of the Related Art

Discs based on the BD (Blu-ray Disc) or HD-DVD (High-Definition DVD) technology have been standardized as the large-capacity optical discs that use blue laser light, and the development of optical disc devices for these discs has already been announced. A three-wavelength optical laser disc device applicable to all these optical discs, including conventional CDs and DVDs, has also been developed and this device requires that the kind of optical disc mounted therein should be accurately discriminated.

Conventional methods of discriminating the type of mounted disc utilize the fact that the distance from the disc surface to the recording surface, that is, focal depth, differs according to the kind of disc. The conventional methods alone, however, are ineffective for discrimination between a disc of the DVD format and a disc of the HD-DVD format, since both types of discs are of the same distance from the disc surface to the recording surface. Accordingly, JP-A-2006-31779 discloses a method of discriminating between a disc of the DVD format and a disc of the HD-DVD format. The method disclosed in JP-A-2006-31779 is based on a period of a push-pull signal which is output when laser light is focused upon the disc and an optical pickup is moved in a radial direction of the disc. Also, JP-A-2006-179127 discloses a method of discriminating between a disc of the DVD format and a disc of the HD-DVD format by moving an optical pickup in a radial direction of the disc and detecting whether the disc has changed in track pitch during the movement. The method disclosed in JP-A-2006-179127 utilizes the fact that HD-DVD differs in track pitch between a system lead-in region and a data region.

### SUMMARY OF THE INVENTION

The techniques described in the above two patent documents are both based on moving the optical pickup in the radial direction of the disc (this movement is referred to as seek operation) and detecting the difference in track pitch. Hence, both techniques require that the step of moving the optical pickup should be added to discriminate, and that during the movement of the pickup, a speed thereof should be accurately controlled. To realize high-speed recording and playback in an optical disc device, a disc that has been mounted in the device must be discriminated rapidly. In this context, the above-described techniques have their limits.

An object of the present invention is to provide an optical disc device in which a DVD and an HD-DVD can be mounted and which can discriminate between the two types of discs rapidly, and a method of discriminating both disc types.

An optical disc device according to the present invention includes a spindle motor that rotates a mounted optical disc, an optical pickup that irradiates the optical disc with laser light and detects the light reflected from the optical disc, a sled motor that moves the optical pickup in a radial direction of the optical disc, a tracking error signal generator that creates tracking error signals from signals which the optical pickup has detected, and a disc discriminator that discriminates the kind of optical disc by comparing amplitude values of the tracking error signals with a threshold level of the amplitude. After the movement of the optical pickup has been stopped above a data region on the optical disc, the amplitude value “Vdpp” based on a differential push-pull (DPP) method, and the amplitude value “Vdpd” based on a differential phase detection (DPD) method are acquired as the tracking error signals. The disc discriminator discriminates the kind of optical disc by comparing the acquired amplitude values “Vdpp” and “Vdpd” with the threshold level “Vth”.

Another optical disc device according to the present invention includes a spindle motor that rotates a mounted optical disc, an optical pickup that irradiates the optical disc with laser light and detects the light reflected from the optical disc, a sled motor that moves the optical pickup in a radial direction of the optical disc, a tracking error signal generator that creates tracking error signals from signals which the optical pickup has detected, and a disc discriminator that discriminates the kind of optical disc by comparing amplitude values of the tracking error signals with a threshold level of the amplitude. After the movement of the optical pickup has been stopped above a data region and system lead-in region or lead-in region equivalent thereto on the optical disc, the amplitude values “Vdata” and “Vlead” of the tracking error signals are acquired and the disc discriminator discriminates the kind of optical disc by comparing the acquired amplitude values “Vdata” and “Vlead”.

A method for discriminating an optical disc according to the present invention includes: rotating an optical disc; detecting reflected light with an optical pickup stopped above a data region on the optical disc; acquiring amplitude value “Vdpp” based on a DPP method and amplitude value “Vdpd” based on a DPD method as tracking error signals from the detected optical signals; and discriminating the kind of optical disc by comparing the acquired amplitude values “Vdpp” and “Vdpd” with a threshold level “Vth”.

Another method of discriminating an optical disc according to the present invention includes: rotating an optical disc; detecting reflected light with an optical pickup stopped above a data region and system lead-in region or lead-in region equivalent thereto on the optical disc; acquiring amplitude values “Vdata” and “Vlead” of tracking error signals of a DPP method from the optical signals that have been detected above the respective regions; and discriminating the kind of optical disc by comparing the acquired amplitude values “Vdata” and “Vlead”.

According to the present invention, an optical disc device in which a DVD and an HD-DVD can be mounted contributes to faster recording or playback since the device discriminates between the two types of discs more rapidly.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an embodiment of an optical disc device according to the present invention;

FIG. 2 is a diagram showing a detailed configuration of a tracking error signal generator 9;

FIG. 3 is a diagram that shows HD-DVD and DVD recording formats for comparison;

FIG. 4 is a diagram showing a flowchart of disc discrimination (with first and second discrimination methods combined) in the embodiment;

FIG. 5 is a diagram showing a relationship between amplitude and threshold level of a TE signal used in DVD/HD-DVD discrimination;

FIGS. 6A and 6B are diagrams that show flowcharts of disc discrimination (using a third discrimination method) in the embodiment; and

FIGS. 7A and 7B are diagrams that show methods of moving a pickup during DVD/HD-DVD discrimination.

### DETAILED DESCRIPTION OF THE EMBODIMENT

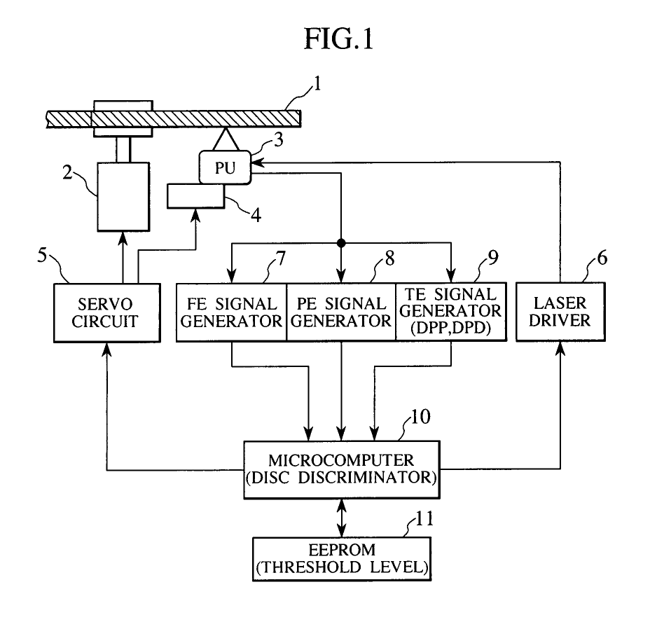

FIG. 1 is a block diagram showing an embodiment of an optical disc device according to the present invention. This device of a three-wavelength laser-applicable type is constructed so that a large-capacity optical disc (BD or HD-DVD), a conventional DVD (DVD-ROM, DVD-RAM, DVD-R, DVD-RW, DVD+R, or DVD+RW) or CD, or the like can be mounted as an optical disc 1. The optical disc 1 is rotated by a spindle motor 2, and an optical pickup 3 is driven by a sled motor 4 and moves in a radial direction of the optical disc 1. Laser light of desired intensity is irradiated at a desired wavelength from the optical pickup 3 via an objective lens not shown, and the kind of mounted optical disc 1 is discriminated by using the emitted laser light. The optical pickup 3 also writes a signal onto the optical disc 1 or reads the signal therefrom. During the signal write/read operation, the objective lens is driven by an actuator not shown, and moves in steps of very short distances in a focusing direction and in a tracking direction. A servo circuit 5 controls the spindle motor 2, the sled motor 4, and the actuator. The emitted laser light is controlled by a laser driver 6. Reflected light from the optical disc 1 is converted into an electrical signal by a detector provided inside the optical pickup 3. The detected signal is used for an FE signal generator 7 to create a focus error (FE) signal, for a PE signal generator 8 to create a sum signal (PE signal), and for a TE signal generator 9 to create a tracking error (TE) signal. A microcomputer (disc discriminator) 10 compares amplitude values of the above-created signals with a threshold level, thus discriminating the kind of disc. Signal threshold levels required for the discrimination of the optical disc are stored within an EEPROM 11.

The TE signal generator 9 uses both a differential push-pull (DPP) method and a differential phase detection (DPD) method to generate tracking error signals.

The DPP method is effective for optical discs on which recording tracks are helically formed along guide grooves. In the DPP method, laser light for irradiating the optical disc is split into a main beam and a sub-beam, then the sub-beam is emitted to a position shifted through ½ of a track with respect to the main beam, and a differential between a tracking error signal component of the main beam and that of the sub-beam is acquired as a tracking error signal.

The DPD method, on the other hand, is used for playback-only optical discs free from the above-mentioned guide grooves. In the DPD method, tracking error signals are generated by phase difference detection from rows of convex and concave pits formed in association with information signals. The DPD method, although naturally inapplicable to recording-only optical discs that contain no recorded data, can be applied to recording-only optical discs that contain recorded data.

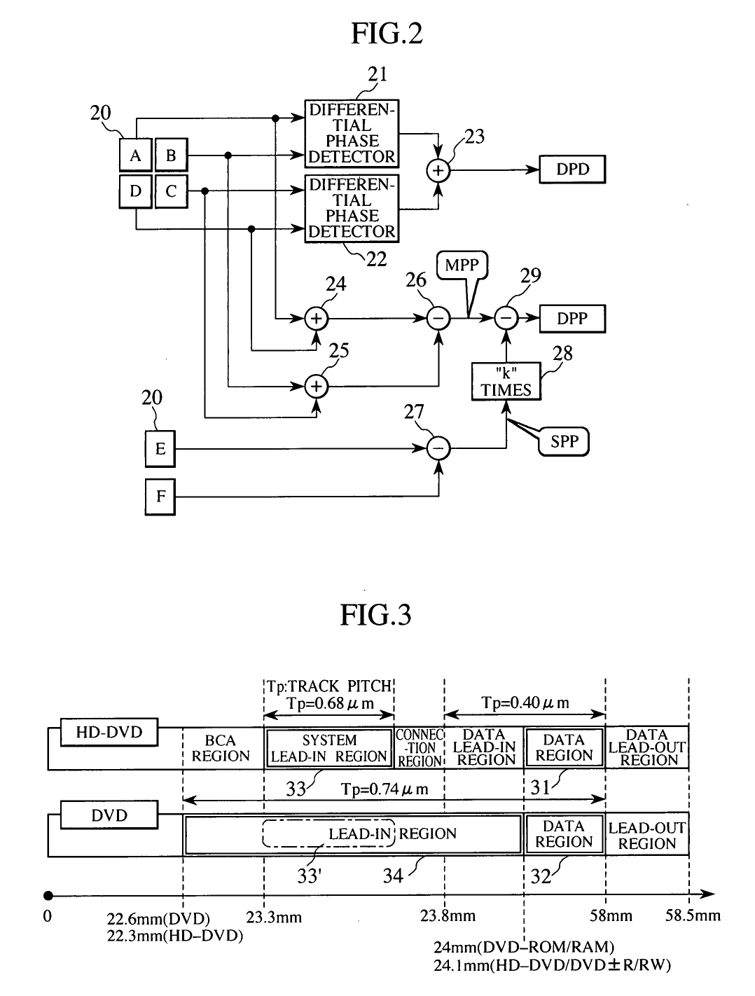

FIG. 2 is a diagram showing a detailed configuration of the tracking error signal generator 9 shown in FIG. 1. Generation of a TE signal based on the DPD method and generation of a TE signal based on the DPP method will be described below.

A light-receiving element of the optical pickup 3 has a plurality of detectors 20 formed by splitting a light-receiving region. These detectors allow the light-receiving element to be applied to a three-beam method. Detector output signals for the main beam are expressed as A to D, and detector output signals for the sub-beam, as E and F.

First, TE signal generation based on the DPD method is described below. A differential phase detector 21 detects a phase difference between the signals A and B associated with a pit row, and a differential phase detector 22 detects a phase difference between the signals C and D associated with another pit row. If the light spot is present centrally in the pit, the two signals are in phase, but if the spot is off-center, a phase difference occurs. In the latter case, both signals are added by an adder 23, and a TE signal based on the DPD method is generated.

Next, TE signal generation based on the DPP method is described below. Regarding the main beam, an adder 24 adds the signals A and D associated with the guide groove (A+D addition), and an adder 25 adds the signals B and C associated with the guide groove (B+C addition). A subtractor 26 conducts a subtraction between the above two addition results [(A+D)−(B+C)], thus obtaining a main push-pull (MPP) signal. Regarding the sub-beam, a subtractor 27 subtracts the signal F from the signal E [(E−F) subtraction] and obtains a sub-push-pull (SPP) signal. A gain controller 28 multiplies the SPP signal by a factor of “k” and conducts control for essentially the same amplitude as that of the MPP signal. The MPP signal and SPP signal here are opposite to each other in phase. A subtractor 29 subtracts the SPP signal (after multiplied by “k”) from the MPP signal and generates a TE signal based on the DPP method.

Methods of disc discrimination in the present embodiment are outlined below.

(First discrimination method): Focal depth “d” from the disc surface to a recording surface is calculated by using the light reflected from the optical disc (PE signal). Discrimination based on the focal depth “d” is conducted. If “d”=0.1 mm, the disc is a BD; if “d”=1.2 mm, the disc is a CD; if “d”=0.6 mm, the disc is a DVD or an HD-DVD.

(Second discrimination method): Discrimination between a DVD and an HD-DVD is conducted by using the tracking error signals (TE signals) of the DPP and DPD methods. During the discrimination, the optical pickup is stopped above the data region on the disc, and amplitude values of the DPP-based and DPD-based TE signals and an amplitude ratio between these signals are each compared with threshold levels.

(Third discrimination method): An amplitude ratio between the DPP-based TE signals obtained at the data region and the system lead-in region or lead-in region equivalent thereto is compared with a threshold level. Discrimination between a DVD and an HD-DVD is thus conducted.

As outlined above, the discrimination between a DVD and an HD-DVD uses the second or third discrimination method. The principles of operation are described below.

FIG. 3 is a diagram that shows HD-DVD and DVD recording formats for comparison. As well known, track pitch “Tp” differs between an HD-DVD and a DVD. “Tp” values at respective data regions 31, 32 are 0.40 μm for the HD-DVD, and 0.74 μm for the DVD. Also, a “Tp” value of the HD-DVD at the system lead-in region 33 thereof differs from the “Tp” value at the data region 31 and is 0.68 μm. A “Tp” value of the DVD at the system lead-in region 34 thereof is equal to the “Tp” value at the data region 32.

In the present embodiment that focuses attention upon these values of the track pitch “Tp”, the fact that the amplitude of the tracking error signals differs according to the particular difference in “Tp” is utilized and this difference is detected as the difference in amplitude between the TE signals. In the second discrimination method, the amplitude ratio between the TE signals of the DPP and DPD methods is also evaluated. In this evaluation, a decrease in the DPP-based signal amplitude, based on a relationship between “Tp” and the laser spot diameter, is detected and the decrease is used for discrimination. In the present embodiment, since the amplitude of the TE signals is detected, there is no need to move the optical pickup in the radial direction of the disc when the TE signals are measured. Therefore, the time required for the measurement is reduced and the discrimination of the disc can be correspondingly rapid. Even with the optical pickup stopped above a desired region (e.g., the data region), a TE signal of a sine waveform can be obtained since misalignment of the disc makes the optical pickup traverse the track. Amplitude of this TE signal depends on an off-track level, that is, the track pitch. Accordingly, a differential track pitch can be detected by comparing the amplitude of the TE signal.

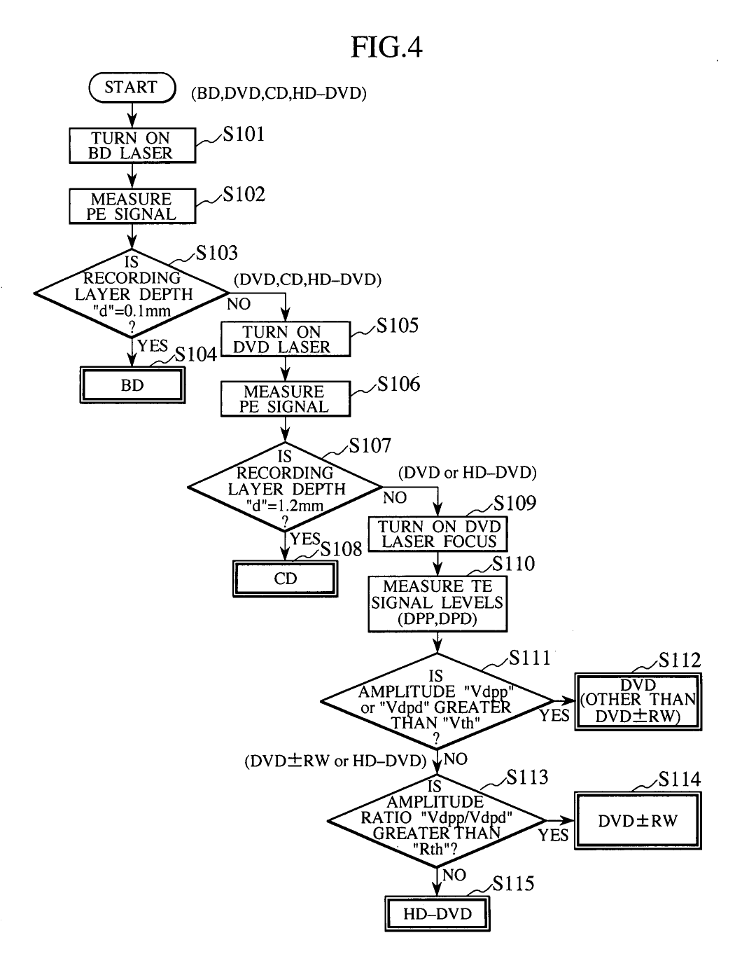

FIG. 4 is a diagram showing a flowchart of the disc discrimination using a combination of the first and second discrimination methods. This discrimination method can be applied to all kinds of discs (BD, DVD, CD, HD-DVD). The following describes the discrimination method:

First, the mounted optical disc is irradiated with BD laser light (step S101). While the objective lens in the pickup is being slid to face of the optical disc, the intensity of the sum signal (TE signal) of the light reflected is measured by using the PE signal generator 8 (step S102). Since an arrival of the laser beam spot at the recording surface maximizes the PE signal level, focal depth “d” from the disc surface to the recording surface is calculated (step S103). If the depth “d”=0.1 mm, the disc discriminator discriminates that the disc is a BD (step S104). If the depth “d” is not 0.1 mm, the laser light is changed to DVD laser light (step S105) and then PE signal intensity is likewise measured (step S106). The depth “d” to the recording surface is calculated (step S107) and if “d” is 1.2 mm, the disc discriminator discriminates that the disc is a CD (step S108).

If the disc is neither a BD nor a CD (i.e., if “No” in step S107), control is returned to DVD laser light irradiation and after the disc has been rotated, the pickup is moved to a position above the data region (denoted by reference number 31 or 32 in FIG. 3) on the disc. Next, a focus servo is turned on (step S109), then a tracking servo is turned off, and the TE signal generator 9 is activated to measure tracking error (TE) signals of the DPP and DPD methods (step S110). Amplitude values of the measured TE signals are defined as “Vdpp” and “Vdpd”, and both are compared with a threshold level “Vth” (step S111). If at least one of the two amplitude values (i.e., either “Vdpp” or “Vdpd”) is greater than the threshold level “Vth”, the disc discriminator discriminates that the disc is a DVD (DVD±RW excluded) (step S112). The criterion of “at least one of the two amplitude values” is due to the fact that since unrecorded discs have no pits, the amplitude of “Vdpd” is not subjected to evaluation. Also, DVD±RW has been excluded because the “Vdpp” and “Vdpd” values of this DVD, compared with those of other DVDs, are too small for the “Vth”-based discrimination from HD-DVD.

In order to discriminate between HD-DVD and DVD+RW, the ratio between the amplitude values “Vdpp” and “Vdpd” is calculated and the amplitude ratio “Vdpp/Vdpd” is compared with a threshold level “Rth” (step S113). If the amplitude ratio “Vdpp/Vdpd” is greater than the threshold level “Rth”, the disc discriminator discriminates that the disc is a DVD RW (step S114). If the amplitude ratio is equal to smaller than “Rth”, the disc discriminator discriminates that the disc is an HD-DVD (step S115). That is to say, if both the amplitude value “Vdpp” and the amplitude value “Vdpd” are equal to or smaller than the threshold level “Vth” and the amplitude ratio “Vdpp/Vdpd” is equal to or smaller than the threshold level “Rth”, the disc discriminator discriminates that the disc is an HD-DVD. All kinds of discs (BD, DVD, CD, HD-DVD) can thus be discriminated.

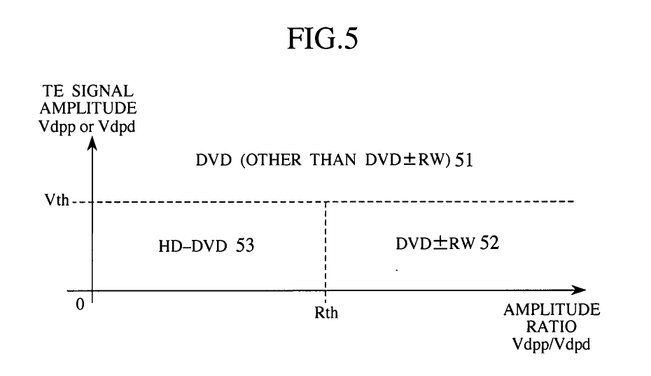

FIG. 5 is a diagram showing the relationship between the amplitude and threshold level of the TE signal used in DVD/HD-DVD discrimination. First, if the amplitude “Vdpp” or “Vdpd” of the TE signal is greater than the threshold level “Vth”, the disc discriminator discriminates that the disc is a DVD (DVD±RW excluded) 51 (step S111, S112). A value of 550 mV, for example, is appropriate as the threshold level “Vth”. If both “Vdpp” and “Vdpd” are equal to or smaller than the threshold level “Vth”, the amplitude ratio “Vdpp/Vdpd” is evaluated. If “Vdpp/Vdpd” is greater than the threshold level “Rth”, the disc discriminator discriminates that the disc is a DVD±RW 52. If “Vdpp/Vdpd” is equal to or smaller than the threshold level “Rth”, the disc discriminator discriminates that the disc is a DVD±RW 53. (See steps S113, S114, S115). These judgments are due to the fact that since the HD-DVD, despite its small “Tp”, is irradiated with the DVD laser light of a large spot diameter, the spot comes into contact with an adjacent track and the contact reduces “Vdpp” and hence “Vdpp/Vdpd”. A value of 0.3, for example, is appropriate as the threshold level “Rth”.

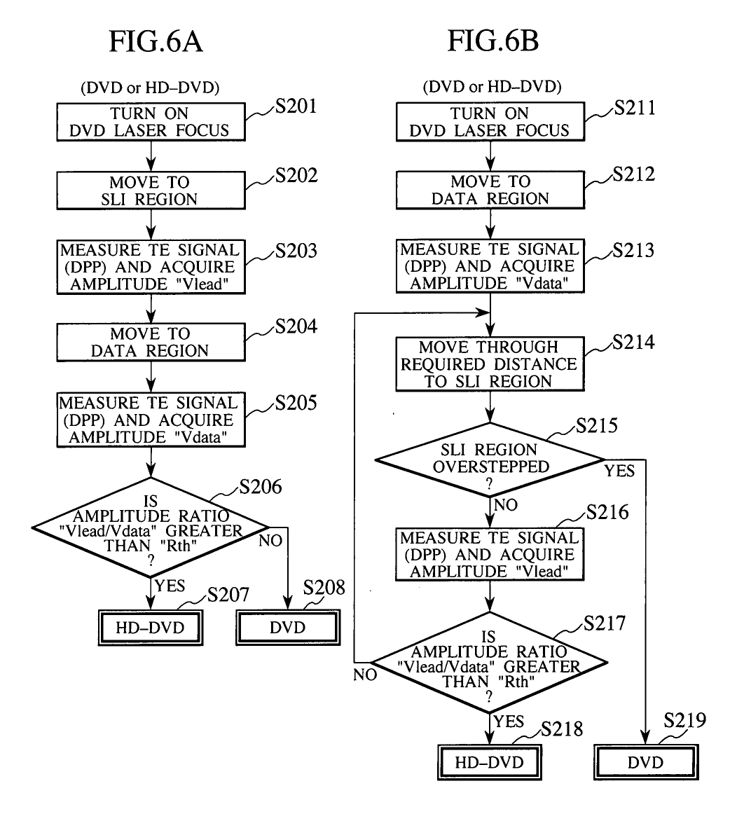

FIGS. 6A and 6B are diagrams that show flowcharts of the disc discrimination using the above-outlined third discrimination method. In this case, all kinds of discs can be discriminated by combining the above first discrimination method. Description of the first discrimination method is omitted herein since this method is the same as in FIG. 4. In the third discrimination method, the TE signals occurring at two regions, namely, the data region and system lead-in (SLI) region on the disc, are measured, which can be conducted in two ways changed in order of the measurement. FIG. 6A shows the way of the measurement with the SLI region first, and FIG. 6B shows the way of the measurement with the data region first.

As shown in FIG. 6A, the focus servo is turned on for the DVD laser light (step S201) and the pickup (objective lens) is moved to a position above the SLI region (denoted by reference number 33 in FIG. 3) on the HD-DVD. For DVD, the pickup (objective lens) is moved to a position above a region (denoted by reference number 33′) equivalent to the SLI region of the lead-in region 34 (step S202). A tracking error (TE) signal of the DPP method is measured by using the TE signal generator 9, and amplitude of the measured TE signal is defined as “Vlead” (step S203). Next, the pickup is moved to a position above the data region 31, 32 (step S204). Once again (but this time, above the data region), a tracking error (TE) signal of the DPP method is measured and amplitude of the measured TE signal is defined as “Vdata” (step S205). A ratio between the amplitude values “Vlead” and “Vdata” is calculated and the calculated amplitude ratio “Vlead/Vdata” is compared with the threshold level “Rth” (step S206). If the amplitude ratio “Vlead/Vdata” is greater than “Rth”, the disc discriminator discriminates that the disc is an HD-DVD (step S207). If “Vlead/Vdata” is equal to or smaller than “Rth”, the disc discriminator discriminates that the disc is a DVD (step S208). More specifically, since the amplitude ratio “Vlead/Vdata” in HD-DVD is about five times as great, HD-DVD can be discriminated by assigning a value of about 3, for example, to the threshold level “Rth”.

As shown in FIG. 6B, the focus servo is turned on for the DVD laser light (step S211) and the pickup (objective lens) is moved to a position above the data region (in FIG. 3, region 31 for HD-DVD or region 32 for DVD) (step S213). A tracking error (TE) signal of the DPP method is measured by using the TE signal generator 9, and amplitude of the measured TE signal is defined as “Vdata” (step S213). Next, the pickup is moved from the above measuring position towards a position above the region 33′ equivalent to the SLI region 31 (for HD-DVD) or 32 (for DVD) through a required distance (e.g., 50 μm) (step S214). Whether the new moving destination is beyond the position at which the SLI region exists is judged (step S215). If the moving destination is not beyond the position of the SLI region, a tracking error (TE) signal of the DPP method is measured at the new destination and amplitude of the measured TE signal is defined as “Vlead” (step S216). A ratio between the amplitude values “Vlead” and “Vdata” is calculated and the calculated amplitude ratio “Vlead/Vdata” is compared with the threshold level “Rth” (step S217). If the amplitude ratio “Vlead/Vdata” is greater than “Rth”, the SLI region 33 for HD-DVD is judged to be present, so the disc discriminator discriminates that the disc is an HD-DVD (step S218). If the amplitude ratio is equal to or smaller than “Rth”, control is returned to step S214 and the pickup is moved through the required distance once again. Measurement of a TE signal is conducted and the previous amplitude “Vlead” is updated. The movement is repeated in this way and if the moving destination is beyond the position of the SLI region, that is, if the judgment in step S215 results in “Yes”, the measurement is stopped. In this case, since the amplitude ratio is judged in step S217 to be equal to or smaller than “Rth”, the SLI region 33 is absent on the disc and the disc discriminator discriminates that the disc is a DVD (step S219).

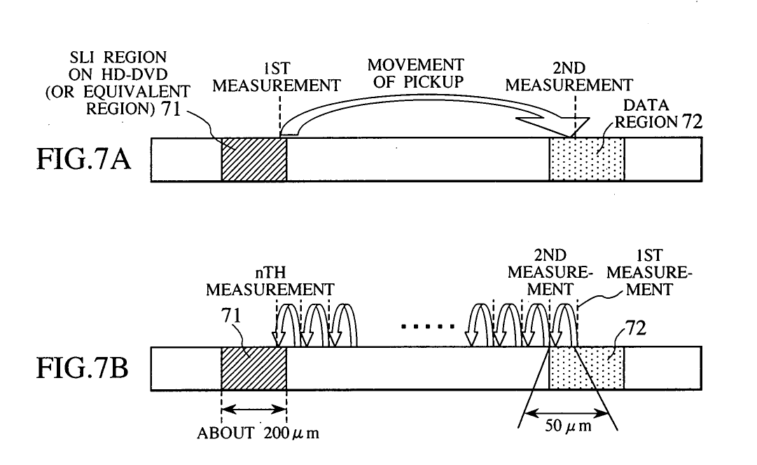

FIGS. 7A and 7B are diagrams that show methods of moving the pickup during the DVD/HD-DVD discrimination processes shown in FIGS. 6A and 6B. FIGS. 7A, 7B are associated with FIGS. 6A, 6B, respectively.

The moving method in FIG. 7A allows the discrimination process to be completed within a short time, since TE signals at two points on the disc can be measured just by conducting a first measurement and a second measurement, in that order. However, sine an SLI region 71 subjected to the first measurement is very narrow (about 200 μm wide), the pickup (objective lens) becomes difficult to position at the SLI region 71. If the positioning for the first measurement fails, disc discrimination results will be wrong. An element for verifying that the positioning has been properly conducted, therefore, is preferably provided.

The moving method in FIG. 7B requires a long discrimination time, since a TE signal measurement is started at a data region 72 first (measurement 1) and then while the pickup is moved in steps of very short distances, TE signal measurements are repeated at other positions (up to measurement “n” at the SLI region). In this method, however, since the pickup can be reliably moved even to the narrow SLI region 71, highly reliable discrimination results can be obtained. The moving methods in FIGS. 7A, 7B have these advantages and disadvantages, and hence, advantageous effects of the present invention can be implemented by selecting the appropriate moving method according to particular conditions of the device.

As described above, the disc discrimination method according to the present embodiment utilizes the amplitude of tracking error signals, so there is no need to move the optical pickup in the radial direction of the disc when the signals are measured. Accordingly, the time required for the measurement is reduced and rapid disc discrimination becomes possible.

While we have shown and described an embodiment in accordance with our invention, it is to be understood that the disclosed embodiment is susceptible of changes and modifications without departing from the scope of the invention. Therefore, we do not intend to be bound by the details shown and described herein, but intend to cover all such changes and modifications that fall within the ambit of the appended claims.

What is claimed is:

1. An optical disc device comprising:
a spindle motor that rotates a mounted optical disc;
an optical pickup that irradiates the optical disc with laser light, the pickup further detecting the light reflected from the optical disc;
a sled motor that moves the optical pickup in a radial direction of the optical disc;
a tracking error signal generator that creates tracking error signals from signals which the optical pickup has detected; and
a disc discriminator that discriminates the kind of optical disc by comparing amplitude values of the tracking error signals with a threshold level of the amplitude;
wherein:
after the movement of the optical pickup has been stopped above a data region on the optical disc, the amplitude value “Vdpp” based on a differential push-pull (DPP) method, and the amplitude value “Vdpd” based on a differential phase detection (DPD) method are acquired as the tracking error signals; and
the disc discriminator discriminates the kind of optical disc by comparing the acquired amplitude values “Vdpp” and “Vdpd” with the threshold level “Vth”.

2. The optical disc device according to claim 1, wherein:
the disc discriminator discriminates the kind of optical disc by calculating an amplitude ratio “Vdpp/Vdpd” between the acquired amplitude values “Vdpp” and “Vdpd” and comparing the amplitude ratio “Vdpp/Vdpd” with a threshold level “Rth”.

3. The optical disc device according to claim 2, wherein:
if the acquired amplitude values “Vdpp” and “Vdpd” are both equal to or smaller than the threshold level “Vth” and the amplitude ratio “Vdpp/Vdpd” is equal to or smaller than the threshold level “Rth”, the disc discriminator discriminates that the optical disc is an HD-DVD.

4. An optical disc device comprising:
a spindle motor that rotates a mounted optical disc;
an optical pickup that irradiates the optical disc with laser light, the pickup further detecting the light reflected from the optical disc;
a sled motor that moves the optical pickup in a radial direction of the optical disc;
a tracking error signal generator that creates tracking error signals of a DPP method from signals which the optical pickup has detected; and
a disc discriminator that discriminates the kind of optical disc by comparing amplitude values of the tracking error signals with a threshold level of the amplitude;
wherein, after the movement of the optical pickup has been stopped above a data region and system lead-in region or lead-in region equivalent thereto on the optical disc, the amplitude values “Vdata” and “Vlead” of the tracking error signals are acquired and the disc discriminator discriminates the kind of optical disc by comparing the acquired amplitude values “Vdata” and “Vlead”.

5. The optical disc device according to claim 4, wherein:
the disc discriminator calculates an amplitude ratio “Vlead/Vdata” between the acquired amplitude values “Vlead” and “Vdata”, and if the amplitude ratio “Vlead/Vdata” is equal to or greater than a threshold level “Rth”, discriminates that the optical disc is an HD-DVD.

6. A method for discriminating a mounted optical disc by irradiating the optical disc with laser light from an optical pickup and then detecting the light reflected, the method comprising the steps of:
rotating the optical disc and then detecting the reflected light with the optical pickup stopped above a data region on the optical disc;
acquiring amplitude value “Vdpp” based on a DPP method and amplitude value “Vdpd” based on a DPD method as tracking error signals from the detected optical signals; and
discriminating the kind of optical disc by comparing the acquired amplitude values “Vdpp” and “Vdpd” with a threshold level “Vth”.

7. The method for discriminating an optical disc according to claim 6, the method further comprising the step of:
calculating an amplitude ratio “Vdpp/Vdpd” between the acquired amplitude values “Vdpp” and “Vdpd” and discriminating the kind of optical disc by comparing the calculated amplitude ratio “Vdpp/Vdpd” with a threshold level “Rth”.

8. A method for discriminating a mounted optical disc by irradiating the optical disc with laser light from an optical pickup and then detecting the light reflected, the method comprising the steps of:
rotating the optical disc and then detecting the reflected light with the optical pickup stopped above a data region and system lead-in region or lead-in region equivalent thereto on the optical disc;
acquiring amplitude values “Vdata” and “Vlead” of tracking error signals of a DPP method from the optical signals that have been detected above the respective regions; and
discriminating the kind of optical disc by comparing the acquired amplitude values “Vdata” and “Vlead”.

9. The method for discriminating an optical disc according to claim 8, wherein:
first, the amplitude value “Vlead” of either of the tracking error signals is acquired by moving the optical pickup to a position above the system lead-in region or lead-in region equivalent thereto on the optical disc; and then
the amplitude value “Vdata” of the other tracking error signal is acquired by moving the optical pickup to a position above the data region on the optical disc.

10. The method for discriminating an optical disc according to claim 8, wherein:
first, the amplitude value “Vdata” of either of the tracking error signals is acquired by moving the optical pickup to a position above the data region on the optical disc; then
the amplitude value “Vlead” of the other tracking error signal is acquired by moving the optical pickup to a position above the system lead-in region or lead-in region equivalent thereto on the optical disc through a required distance; and
moving the optical pickup through the required distance is repeated until a moving destination of the pickup has overstepped the system lead-in region or a lead-in region equivalent thereto, and with each movement of the pickup, the amplitude value “Vlead” is acquired and updated.
